(19) United States
(12) Patent Application Publication
(10) Pub. No.: US 2005/0089164 A1
(43) Pub. Date: Apr. 28, 2005

(54) System and method for the production and distribution of copy-protected and use-protected electronic audio and visual media and the data contents thereof

(76) Inventors: Juergen K Lang, Bergisch Gladbach (DE); Ursula Maria Bing, Bergisch Gladbach (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/495,382

(22) PCT Filed: Dec. 3, 2002
(86) PCT No.: PCT/DE02/04419

(30) Foreign Application Priority Data
Dec. 30, 2001 (DE) 101 64 134.6

(51) Int. Cl. H04N 7/167

(52) U.S. Cl. 380/201

(57) ABSTRACT

The invention relates to a system and to a method for cost-effectively creating and distributing copy-protected and utilization-protected electronic audio and video media and their data contents, whereby the data contents of the electronic media are encrypted in such a way that they cannot be completely played or displayed without the execution of cryptographic processes at the recipient who is authorized within a certain scope of utilization and in such a way that, if the electronic media are transferred to third parties, complete playback is not possible at all or else not without once again carrying out appropriate cryptographic processes. According to the invention, this objective is achieved in that a cryptographic module at the recipient is used that decrypts or deciphers completely or partially encrypted or enciphered data contents of electronic audio and video media or keys for decrypting or deciphering these data contents and subsequently forwards them, again in an encrypted or enciphered form, to a playback unit in such a way that the audio and video information can be played in the playback unit without the electronic data contents being present in unencrypted form along the transmission route, at the input or at the output of the cryptographic module or at the input of the playback unit.

The invention relates to a system and to a method for cost-effectively creating and distributing copy-protected and utilization-protected electronic audio and video media and their data contents, whereby the data contents of the electronic media are encrypted in such a way that they cannot be completely played or displayed without the execution of cryptographic processes at the recipient who is authorized within a certain scope of utilization and in such a way that, if the electronic media are transferred to third parties, complete playback is not possible at all or else not without once again carrying out appropriate cryptographic processes.

It is known that digital electronic media can be secured by various methods in such a way that unauthorized utilization is either made difficult or prevented altogether. Such methods, which will be discussed in greater detail below, serve to prevent the fraudulent use of the electronic media.

By far the most important example of fraudulent use is so-called “sound media piracy”. Here, especially the benefit of digital sound media such as compact discs or MP3 files is utilized to produce identical and thus perfect copies of the original sound media by means of simple copying procedures, and these copies are then circulated for a fee or for free without the knowledge of the author or rights holder and without payment of license fees. Such misuse causes the sound media industry to suffer the loss of substantial license revenues.

The known methods comprise essentially the following:
1. the embedding of identifying additional information such as, for example, “state bits”,
2. the encryption of electronic media,
3. the complete shielding of the area of the playback and storing of digital media and
4. the insertion of electronic watermarks for identifying, for example, the authorship.
   Re 1.:

The (known) method—designated as 1.—for embedding identifying additional information such as “state bits” serves, for example, to augment the audio, video and text information of electronic media with information that indicates the authorship and the authorization for playing and copying. An example of such “copy protection” is individual bits or bytes at defined places in the data stream of the digitally output music information (e.g. in the case of a compact disc, minidisk or digital audio tape) which, depending on the authorization, can assume different values. If the digital audio data provided with such additional information is transmitted digitally from a first playback device to a second device with the intent of making a copy, then, on the basis of the value of the additional information, the second device recognizes whether a copy is allowed to be made or not.

In the known method according to 1., however, the problem exists that such additional information can easily be modified with fraudulent intent in such a way that, in spite of the copy protection, unauthorized copies can nevertheless be made. Early digital sound recording devices for the mass market (such as Digital Audio Tape—DAT—recorders) soon had features inside the device to bridge or circumvent the copy protection by repositioning switches or so-called jumpers. If the additional information has been ascertained, then newer methods for playing digital audio data, for example, via a personal computer (PC), are capable of setting this information to any desired value during the playing or during the copying procedure, thereby rendering this type of copy protection completely ineffective.

This type of protection can be compared to marking a document with the words “TOP SECRET” in order to prevent unauthorized persons from reading this document. (This is largely inadequate protection since it only prevents access by those willing to comply, but does not stop those with fraudulent intent)

Re 2.:

The method—designated as 2.—for encrypting electronic media serves to encrypt electronic data containing, for example, audio information, by using cryptographic keys in such a way that playback is only possible after a preceding decryption procedure. Unauthorized third parties do not have the possibility of flawless playback since they do not have the cryptographic key needed for the decryption.

Such encryption processes are commonly used for digital electronic media as well as for general digital data in data processing, as a rule, during the exchange via unsecured media or unsecured data transmission channels (e.g. the public Internet). Symmetrical or asymmetrical methods or a combination of both (hybrid methods) are employed. With symmetrical methods, the sender and the recipient have to have the same secret key which, for security reasons, has to be exchanged ahead of time via a different transmission channel. As an alternative, in order to avoid the exchange of the sensitive symmetrical key, asymmetrical methods are used in which, as a rule, the sender and the recipient each have an asymmetrical pair of keys consisting of a private and a public key. Whereas the private key always remains with the owner, the public keys can be distributed and exchanged freely. With the principle of asymmetrical encryption, data that is encrypted with the public key of a recipient can only be decrypted with the recipient's private key. Consequently, the encryption of digital data can be secured without exchanging secrets.

In the known method according to 2., however, the problem exists that, even though the digital data of the electronic medium can be reliably protected against unauthorized access, for example, within the scope of an encrypted data transmission, the data is once again available in unencrypted form after the decryption at the recipient. Copies of any kind can then be made again. The effectiveness of encryptions as copy protection is thus limited only to the transmission and possibly also to the archiving of data and thus applies only to an insignificant segment of the life cycle of the digital data. Possibilities for misuse continue to exist.

This type of protection can be compared to the enciphering of a document that, as long as it is in the enciphered state, cannot be read by unauthorized persons (but it can, of course, be read after the deciphering).

Re 3.:

The method designated as 3. for the complete shielding of the area of the playing and storing of digital media serves to hinder or prevent access to the digital data by a user who is acting with fraudulent intent. The pioneer and most important proponent of this method worldwide is the international “Secure Digital Music Initiative” (SDMI). Information on this initiative, including the essential documentation titled “SDMI Portable Device Specification, Part 1, Version 1.0”, dated Jul. 8, 1999 is available free of charge as a .pdf file on the Internet at http://www.sdmi.org.

Since the delimitation of the present invention from this method is of special significance, the method according to SDMI will be discussed in greater detail:

The above-mentioned specification titled “SDMI Portable Device Specification, Part 1, Version 1.0” contains functional requirements for portable devices (PDs) and the associated applications with which a protected environment for digital audio data is to be created. After attaining certification, manufacturers of applications as well as of portable devices can offer their technologies on the market in accordance with the SDMI stipulations, as a result of which technical compatibility is to be achieved.

In terms of content, SDMI is based on a three-phase reference model:
1. so-called applications comprise devices or software for various purposes, among others, for importing unsecured and secured music data of various kinds, for music library management, for example, on a personal computer (PC), for rights management and also for regulating the playback (e.g. on a PC by means of a graphic user interface).
2. so-called “Licensed Compliant Modules (LCM)”, that is to say, a licensed, specification-compliant module that serves as an interface or translation unit between one or more applications and the portable devices (PD) and portable media (PM) mentioned below.
3. so-called portable devices (PD) and portable media (PM) on which the audio information is especially securely stored temporarily and (only for PDs) played.

Although the abstract representation in the cited documentation does not deal concretely with the actual details, a typical application of SDMI could look like this:

A music recipient runs music management and playing software on his/her PC. The purpose of this software is:
to download music from the Internet, to store it locally on the hard drive and to play it (a very realistic scenario in view of the current developments relating to “MP3” piracy, for example, via the Internet file-sharing network “Napster”).
to load music from existing sound media (for example, in the case of audio CDs, via the built-in CD-ROM drive of the PC), either to play it immediately, to store it on the local hard drive or to convert it into other audio formats.
to create (especially to compress) other audio formats in such a way that they can be transferred to so-called portable devices. (Here, too, examples include relatively compact MP3 data records that the PC can temporarily download into the data memory of small portable devices.)
to conveniently manage all of the audio data that is available as data records from the PC (e.g. from the local hard drive) and to play them (e.g. in the form of a graphically displayed “disk jockey workstation” where the available titles can be selected and mixed and where the sound quality can be manipulated).

SDMI uses the following methods for this:

With so-called screening, the application, that is to say, the software on the PC, checks the incoming data. The ambitious objective of this checking procedure is to distinguish between “SDMI protected content” and “not SDMI protected content”, so as to detect illegal copies. Moreover, it is the task of the application to assess and to comply with the “usage rules”, that is to say, the accompanying rights pertaining to the utilization of the piece of music (e.g. how often the piece can be copied or played).

If the verification by the application confirms the authorization for playing or copying this piece of music, then it is transferred to the LCM (second level of the above-mentioned reference model). This transfer takes place via a highly secure channel, the so-called “secure authenticated channel” (SAC). For the SAC, an authentication of both parties (in this case, the application and the LCM) are required as well as some kind of protection of the contents. Even if this is not explicitly mentioned, there are indications that this protection could be a cryptographic encryption method (See Section 5.2.4.1.2).

The LCM once again verifies that the usage conditions are not being violated and initiates a transfer, as a rule, to a portable device. Here, apparently in interaction between the LCM and the application (also via the SAC?), interesting modalities of use, such as the “check-in” and “check-out”, are provided. When the audio medium is transferred to the portable device, it is noted on the local copy of the audio medium on the PC that one copy (for example, out of three permitted copies) has been issued or rather loaned out (check-out). Only after the subsequent “return” of the copy that is no longer needed on the portable device (check-in) are the copying authorizations once again completely restored. This is intended to allow a few private copies for temporary use, but to prevent commercial pirated copies on a large scale.

The audio information is transferred to the portable device, once again, via a SAC. Here, too, an authentication procedure between the portable device and the LCM as well as a protection of the data contents should take place.

The same also applies when so-called portable media (PM) are used between the LCM and the portable device. These media, which can perhaps be memory modules or diskettes that can be exchanged in the portable device in order to augment the playable repertory, are subject to the protection of the SAC.

No explanation is given about the way in which such an authentication between an LCM and a portable medium (PM) is to take place when this medium is a regular data storage medium such as, for example, a diskette, a minidisk or a memory module. After all, an authentication between a passive element, such as a storage medium, and an active element, such as the LCM, is fundamentally difficult.

At the latest at this point, the person skilled in the art realizes that the SDMI method has a security gap that cannot be bridged with conventional means. Since a passive data storage medium such as a diskette, which can also be read outside of the scope of influence of SDMI, cannot be protected against the creation of perfect duplicates, at this point, in spite of the previously taken security measures, the door is wide open for innumerable pirated copies. After all, a perfect duplicate of the PM contains bit by bit and byte by byte exactly the same digital information as the original and consequently, the subsequent portable device (PD) cannot distinguish it from the original, nor can the thousands of portable devices (PDs) to which the thousands of duplicates are distributed. This security gap could be bridged in the specification in that, even with the use of portable media PM, direct contact between the LCM and the PD would be required regularly in order to query whether portable media stemming from other LCMs were being played. At the same time, however, the quite sensible possibility, namely, that portable devices (PD) could receive their portable media PM from different LCMs as the source, would have to be eliminated.

Another alternative for remedying the security gap of the portable medium (PM) would be to provide it with an active component (e.g. a microcontroller) that actively monitors the medium and all copying attempts (this could be unacceptable from a cost standpoint since the portable medium would then be almost as expensive as a separate portable device). Moreover, equating the portable medium with transmittable data records (e.g. via the Internet) would not be possible then since transmitted data records cannot contain any active components.

Another alternative would be to configure the portable medium in such a way that it can be used exclusively (!) by SDMI devices. In actual practice, this would mean that a medium that differs from the market standard and that has a special design, special contacting features and special formatting would have to be created whose content could not be discovered, even by an expert. This would involve an expensive proprietary protection consisting merely of obscurity. Such “security by obscurity” is no longer felt to be in tune with the times by experts in IT security since, in the meantime, secure public methods exist with which extremely high security can be ensured without obscuring the mode of operation. Aside from this, in the case of this alternative, the very sensible approach of equating a portable medium with a data transmission, for example, via the Internet, would not exist.

At this point, all in all, the important question arises, which cannot be answered on the basis of the documentation, as to how SDMI intends to effectuate the electronic transmission of already secured data.

At another place, SDMI also moves in the direction of obscurity. In the first amendment entitled “Amendment 1 to SDMI Portable Device Specification, Part 1, Version 1.0” (likewise available at http://www.sdmi.org), for example, at the bottom of page 2, the requirement is made that additional information in the form of “state bits” (so-called “copy control” or “no more copy” state) NOT be mentioned in technical specifications and that they may not be made available to the general public either directly or indirectly. This is also an outdated approach involving “security by obscurity” which, especially in the case of widely disseminated data from sound media, cannot achieve the desired effect since ambitious experts can even legally acquire and publish such information by means of empirical measurements.

Finally, when it comes to the security of the overall system, it should be mentioned that all of the components of the SDMI system have to meet the likewise specified “robustness requirements”. Experts in the realm of cryptography who fead these requirements will surely be reminded of so-called “cryptographic modules” of the type defined, for example, in U.S. NIST Standard FIPS 140. The use of such modules would also explain how the individual components such as the application, the LCM and at least the portable device (PD) could succeed in rendering the authentication required according to SAC and as well as an encryption manipulation-proof. At the latest with the portable medium (PM), however, the comparison to FIPS 140 breaks down for the above-mentioned reasons.

In summarizing, it can be stated that, in spite of the lack of in-depth details in the documentation, the method of SDMI consists of at least three interacting components (applications, LCM and portable device; the portable medium is not dealt with any further because of the possible security gaps), whereby said components exchange information that has been authenticated and secured by means of the SAC. Each of these components could consist of a cryptographic module in the classical sense. The task of the first module (application) would be to check the incoming data. The task of the second module (LCM) would be to forward and, if necessary, to translate the data, and the task of the third module (portable device) would be to keep the data stored and ready to be played.

Finally, it should be pointed out that with SDMI, the actual task of providing secure sound media or audio data records has not yet been successfully achieved, at least not with the current status of the document. After all, the actually envisaged task to be achieved was to secure the exchange of audio data material via portable media PM as well as via data transmission in such a way that no pirated copies can be made. In spite of the overabundance of security elsewhere (the use of a full three cryptographic modules), however, SDMI does not manage to ensure the security of the portable media without turning to outdated and inadequate security means (state bit). Therefore, the exchange of SDMI-secured audio data by means of data transmission (that is to say, without a portable medium (PM)), an aspect which will be extremely important in the future, is in fact totally unregulated!

This type of protection can be compared to a vault which is secured in several ways and into which a document has to be placed before it can be stored or viewed. If the document is to be read somewhere outside of the vault, it has to be transferred, while still in the vault, into another portable, sealed vault in which there is a device that reads out the wording of the document in a way that it can be understood outside (in part, excessive, inconvenient protection and in part, an absence of protection: electronic transmission, for example, by fax would be unregulated).

Re 4.:

The process designated as 4. and used for applying electronic watermarks for identifying, for example, authorship, is technically speaking only indirectly a suitable method to prevent the production of unauthorized copies, for instance, of audio and video media. For the sake of completeness, however, it is mentioned here since, for two reasons, its use can have a deterring effect in the creation of unauthorized pirated copies of audio and video media: first of all, through the undetected presence of watermarks of the author, and secondly, through the inadvertent insertion of individual watermarks by the pirate copiers themselves.

The principle of the electronic watermark consists in changing the useful data range of electronic audio or video data in such a way that additional information is inserted that is not noticed during normal use, in other words, it is “hidden” in the audio or video material in a manner of speaking, but it can be read out again by the producer of the watermark. The quality of such electronic watermarks either stands out for being “robust” and being retained during copying procedures and perhaps during minor data manipulations (filtering or audio processing) and can be recognized or—precisely the opposite—they are “fragile” and are destroyed during any manipulation.

In actual practice, for example, the author often provides electronic images with watermarks so that these images can be identified later or individual features can be checked. As a rule, the producers of the copies do not know that they have either also copied or else destroyed a watermark.

In the known method according to 4., however, the problem arises that the digital data of the electronic medium can be provided with a watermark but that this measure does not prevent the production of unauthorized copies.

Particularly in the case of mass-produced media sold in identical form (that is to say, also with an identical watermark) such as, for example, sound media, this type of marking by the author would not even serve as a deterrent since the watermark could even confirm the authenticity and thus the quality of the pirated copy itself. Only with mass-produced copies of media containing individual information of the unauthorized copier, in conjunction with processing and playing devices that are appropriately equipped to carry out the verification procedure and that cannot be manipulated, could a protective function then be achieved at great effort.

This type of protection can be compared to a text document in which a hidden message is concealed (e.g. combining the first letter of each word yields a meaning of its own). Copies of this document can still be made with or without knowledge of the watermark.

All of the known methods equally entail the problem that it is not possible to generate, distribute and store electronic audio and video media in such a way as to reliably prevent the production or playing of illegitimate copies, that is to say, so-called pirated copies. Either the security measures can be easily bridged (as in the case of the state bits) or the security measures only work temporarily (as in the case of encryption) or the security measures involve extensive security which, however, fails (as in the case of SDMI) precisely at the most crucial place, namely, the electronic transmission of protected data via an unsecured data transmission channel (e.g. Internet), or the security measures have at best a deterring effect in view of the fact that the legitimate authorship can be demonstrated (electronic watermark).

The invention is based on the objective of further improving existing systems and methods of copy protection of electronic audio and video media and their data contents in order to improve the cost efficiency in such a way that their complete playback or display cannot take place without carrying out cryptographic processes at the recipient who is authorized within a certain scope of utilization and that, in the case of transmission of the electronic media to third parties, the complete playback cannot take place at all or cannot take place without once again carrying out appropriate cryptographic processes so that pirated copies can be reliably prevented.

According to the invention, this objective is achieved in that a cryptographic module at the recipient is used that decrypts or deciphers completely or partially encrypted or enciphered data contents of electronic audio and video media or keys for decrypting or deciphering these data contents and subsequently forwards them, again in an encrypted or enciphered form, to a playback unit in such a way that the audio and video information can be played in the playback unit without the electronic data contents being present in unencrypted form along the transmission route, at the input or at the output of the cryptographic module or at the input of the playback unit.

Advantageously, the system is configured and the method is carried out in such a way that the cryptographic module can distinguish among various encryptions, whereby the distinction allows conclusions to be drawn about the authorship, ownership and utilization rights, for example, to play the media or to make copies.

An advantageous embodiment of the method and a preferred configuration of the system are characterized in that the author, producer, processor or distributor of the electronic audio and video media partially or completely encrypts or enciphers the unencrypted initial data in such a way that the electronic audio and video media or the keys for decrypting or deciphering the electronic audio and video media can be decrypted or deciphered again in the cryptographic module of the recipient.

It is advantageous for the completely or partially performed encryption or enciphering of the electronic audio and video media or of the “melody” keys for decrypting or deciphering these media to take place at the author, producer, processor or distributor with a “media” key which, once again in encrypted or enciphered form, accompanies the electronic audio and video media, whereby the encryption or enciphering of the “media” key is carried out with a “main” key so that it can be reversed in the cryptographic module at the recipient by means of decrypting or deciphering.

Here, it is advantageous that, if need be, all of the encryption or enciphering procedures at the author, producer, processor or distributor, which can be reversed again by means of decryption or deciphering in the cryptographic module at the recipient, can be carried out with two or more alternative encryption or enciphering methods or keys for this purpose.

Advantageously, the “media” key for partially or completely encrypting or enciphering the electronic audio and video media or the “melody” key for decrypting or deciphering these media, which accompanies the electronic audio and video media, is provided with a digital signature that can be verified in the cryptographic module at the recipient.

An advantageous embodiment of the method and a preferred configuration of the system are also characterized in that, after decrypting or deciphering the electronic audio and video information stemming from the author, producer, processor or distributor or the “melody” keys for decrypting or deciphering this information, the cryptographic module at the recipient once again encrypts or enciphers this information in such a way that only a playback unit can decrypt or decipher it.

Here, it is advantageous for the “media” key that is used in the cryptographic module to encrypt or encipher the electronic audio and video information or the “melody” key that is used to decrypt or decipher this information for transmission to the playback unit to be exchanged securely and authentically between the cryptographic module and the playback device.

Moreover, it is advantageous for the “playback” key that is used for transmission to the playback unit for encrypting or enciphering the electronic audio and video information or the “melody” key for decrypting or deciphering this information in the cryptographic module to be generated according to the random principle or according to algorithms that make them more difficult to predict.

Moreover, it is advantageous for the “playback” keys that are used for transmission to the playback unit for encrypting or enciphering the electronic audio and video information or the “melody” key for decrypting or deciphering this information in the cryptographic module to differ from one playback unit to the next.

An advantageous embodiment of the method and a preferred embodiment of the system are also characterized in that, after decrypting or deciphering the audio and video information stemming from the author, producer, processor or distributor or the “melody” key for decrypting or deciphering this information, the cryptographic module at the recipient once again encrypts or enciphers this information in such a way that the cryptographic module is once again capable of decrypting or deciphering this audio and video information or the “melody” keys for decrypting or deciphering this information.

Here, it is advantageous for those “card” keys that are used at the cryptographic module when the cryptographic module itself is supposed to perform the later decryption or deciphering to differ from one cryptographic module to the next.

Another advantageous embodiment of the method and a preferred embodiment of the system are characterized in that, after decrypting or deciphering the audio and video information that was previously encrypted by the “card” key itself or the “melody” key for decrypting or deciphering this information, the cryptographic module at the recipient once again encrypts or enciphers this information or the corresponding “melody” keys in such a way that only a playback unit can decrypt or decipher them.

Additional advantages, special features and practical embodiments of the invention ensue from the subclaims and from the presentation below of preferred embodiments.

The present method and system is to be introduced by several companies in the media industry under the project designation “m.sec”. Below, the special features of m.sec are described.

With the advent of methods and systems for digital audio and video storage, a new level of sound media piracy arose: through so-called “sampling”, the audio and video signals, which had previously existed only in analog form, were unambiguously quantified within the scope of digitalization. Thanks to this unambiguous quantification, for example, in the form of bits and bytes with unambiguous values, perfect copies could be produced for the first time which could no longer be distinguished from the original and which thus suffered no qualitative degradation.

After sound media piracy had already acquired a substantial scope in the form of illegally produced CD copies with the spread of the compact disc, this piracy intensified even further with the advent of the Internet. Due to the large data volume, this was not so much a case of CD copies or audio files in the CD format but rather, sound media piracy was facilitated by a new data format, with which—due to its great compressability—small files could be created that could easily be exchanged via the Internet: the so-called “MP3” format.

MP3 was particularly promoted by the Internet swap network “Napster” which—partially on the edge of legality and partially outside of the law—offered allegedly private exchange transactions between Internet users in a public framework, thereby fostering the illegal transmission of music titles to third parties.

At the latest since MP3 and Napster, the media industry has felt that there is a greater need for a new data format for audio and video data. M.sec meets this need by offering the following advantages:
Digital audio and video data is no longer published unencrypted so that no perfect pirated copies of this original data can be produced.
The audio and video data at the recipient is only decrypted in exchange for payment of a user fee.
Here, variable user fees can be charged.
It is also possible to play parts of the audio and video data (e.g. the first few seconds of a piece of music or the lead of a film) without payment of a user fee.
It is possible to play any parts of the audio and video data without payment of a user fee but with a diminished quality.
The encrypted audio and video data can be provided with certain utilization rights (e.g. the number of times it can be played and copied) as well as other additional information.
When the audio and video data are played, the data is likewise not transferred unencrypted. Decryption only takes place at the time of the so-called digital-analog conversion (D/A conversion).
With the appropriate utilization rights, the recipient can create copies of the audio and video data after payment of a user fee.
These personal copies of the audio and video data are “released” and from then on can be played without further payment of license fees.
Such copies of the audio and video data that the recipient has created after payment of a user fee cannot be readily used by other recipients.

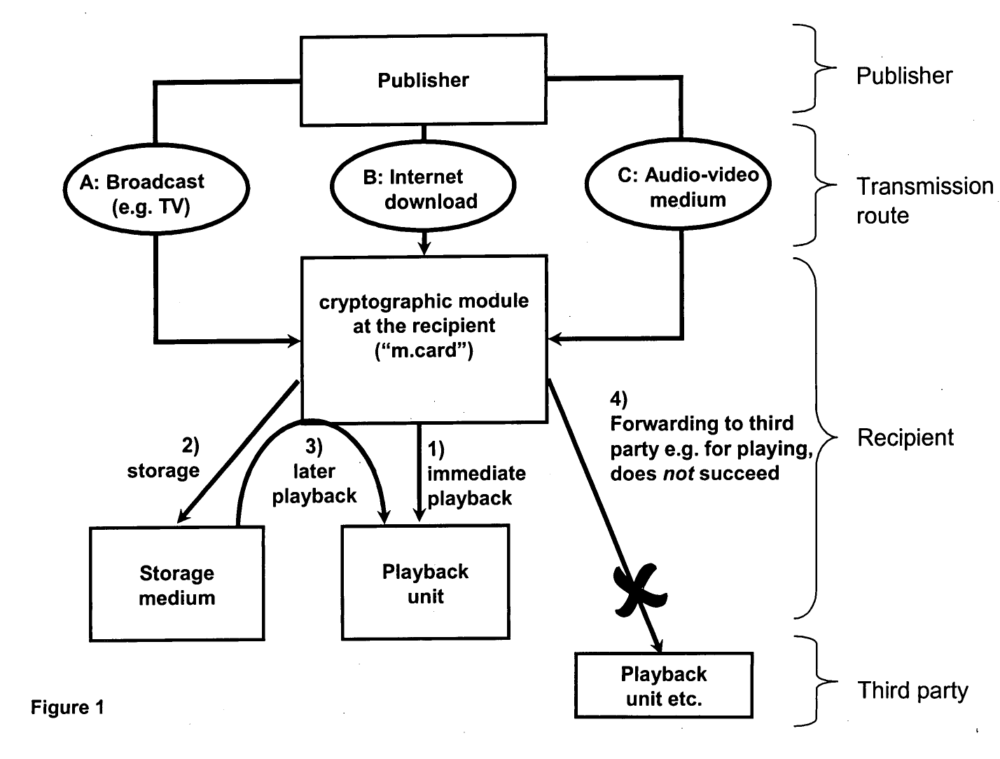

In order to meet these requirements, m.sec comprises the following architecture:
The so-called “publisher” distributes electronic audio and video data that is entirely or partially encrypted. (see “publisher” in FIG. 1)
The recipient has an individual, personalized chip card (the so-called m.card) which, as a cryptographic module, provides functionalities that the recipient cannot manipulate (see “cryptographic module at the recipient, m.card” in FIG. 1)
Appropriate playback and display devices (e.g. personal computer, CD player, Walkman, TV, etc.), in conjunction with the insertable chip card (m.card), offer the possibility to correctly play encrypted audio and video data.

FIG. 1 shows the three possible transmission routes, designated as A, B and C:
With transmission route A (e.g. television), there is a continuous and direct reception of the audio and video data, in the extreme case, in an uninterrupted data stream without beginning or end (so-called “streaming”).
With transmission route B, there is a remote transmission of audio and video media (e.g. as an Internet download) as a rule, in the form of dedicated, complete files.
With transmission route C, the audio and video information is available at the recipient on physically provided audio and video media (e.g. CDs or DVDs).

Here, the following scenarios of use are provided:
1. Playback of transmitted audio and video media (e.g. broadcast TV program)
   If completely or partially encrypted contents of audio and video media are to be received and played immediately, then the m.card serves as the re-encrypting instrument between the encryption by the publisher and the playback unit.
   Here, the encryption by the publisher in the m.card is reversed by means of decryption, the right to play is checked and the playback is initiated. As a rule, this re-encrypting is associated with costs that can be administered, for example, in the cryptographic module. In FIG. 1, this corresponds to the transmission route A in conjunction with the measure at the recipient designated by the number 1), namely, immediate playback.
2. Download and personal release of audio and video data for subsequent playback
   If completely or partially encrypted contents are to be loaded, for example, downloaded from the Internet and released for later personal use, then the m.card serves as a re-encrypting instrument between the encryption by the publisher and the personal encryption with the m.card. As a rule, this re-encrypting is associated with costs that can be administered, for example, in the cryptographic module. In FIG. 1, this corresponds to the transmission route B in conjunction with the measure at the recipient designated by the number 2), namely, the local storing of the information.
   Here, the encryption by the publisher in the m.card is reversed by means of decryption, the right to create a local copy is checked, the encryption with the m.card's own key is carried out and the generation of a copy is initiated.
3. Playback of audio and video data that has been provided by the author on physical media
   If completely or partially encrypted contents of audio and video media are to be played which are provided on physical media, then the m.card serves as a re-encrypting instrument between the encryption by the publisher and the playback unit.
   Here, the encryption by the publisher in the m.card is reversed by means of decryption, the right to play is checked and the playback is initiated. As a rule, this re-encrypting is associated with costs that can be administered, for example, in the cryptographic module. In FIG. 1, this corresponds to the transmission route C in conjunction with the measure at the recipient designated by the number 1), namely, immediate playback.
   If the audio and video information is not temporarily stored in the re-encrypted state as shown in Item 2 in FIG. 1, then, for purposes of repeated playback of the data that has not been re-encrypted, the information can be securely saved by means of the first-time decryption of precisely specified audio and video data either in the cryptographic module itself or else outside of the cryptographic module, provided with a digital signature of the cryptographic module.
4. First and repeated playback of personally released audio and video data
   If contents of audio and video media that have been released and encrypted again with the m.card's own key are to be played back, then the m.card serves as the re-encrypting instrument. As a rule, this re-encrypting is free of charge since a one-time fee for the release was already charged at the time of the original storing operation. In FIG. 1, this corresponds to the measure at the recipient designated by the number 3), namely, later playback.
   Here, the actual encryption of the m.card is reversed in the m.card by means of decryption and the playback is initiated.
5. Forwarding personally released audio and video data to (unauthorized) third parties
   If contents of audio and video media that have been released and encrypted again with the m.card's own key are forwarded to third parties, then the latter does not have the possibility to decrypt them, so that the production of pirated copies is not possible. In FIG. 1, this corresponds to the measure at the recipient designated by the number 4), namely, forwarding to third parties. 6. Forwarding to third parties (optional) of released audio and video data that can be made public again
   If contents of audio and video media (e.g. for a separate fee) are released so that they can be made public again and if they are encrypted again with the m.card's own key, then forwarding to third parties is possible. For third parties, however, the possibility of decryption then exists (e.g. for a fee), in the same manner as this is possible for audio and video data that comes directly from publishers.
      Use of Keys in the Entire System

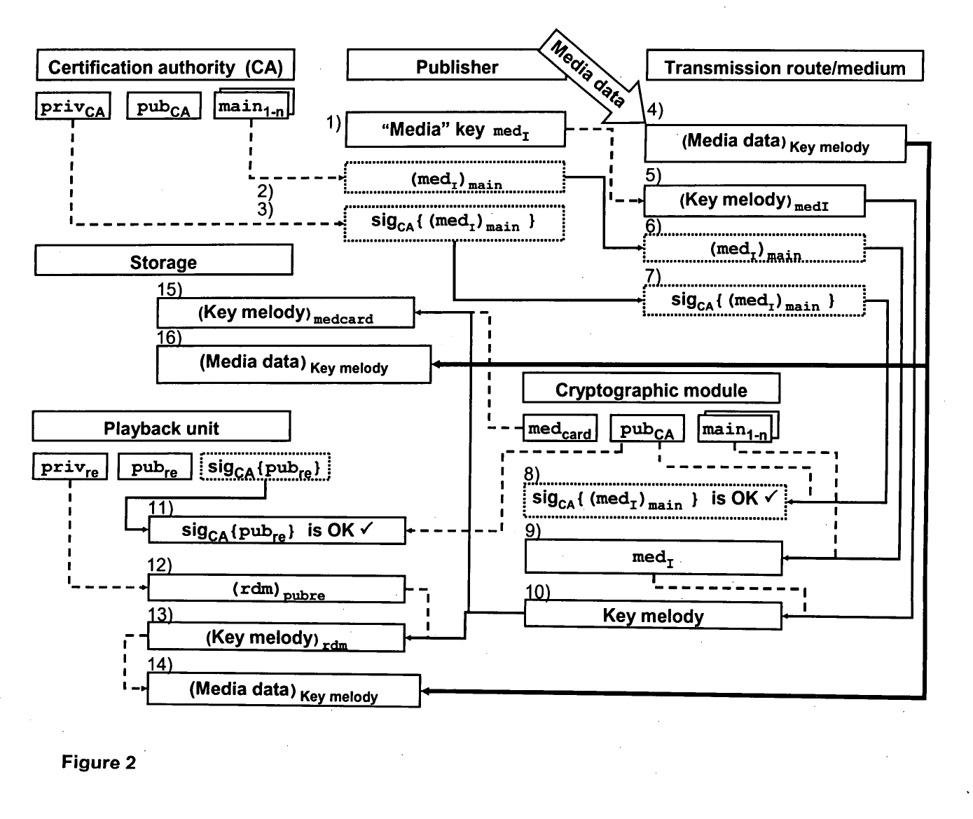

FIG. 2 illustrates the use of keys in the entire system. In addition to the already mentioned participating parties or system components (publisher, transmission channel/medium, cryptographic module m.card, storage and playback unit), there is now a new party, namely, the certification authority (CA) which, as a neutral, trustworthy body or “trust center”, vouches for the issuing of keys.

The following keys are used by the parties:

The certification authority has a so-called first “main” key main₁. Encryptions with this first “main” key can be decrypted with the counterpart to this “main” key, which is present in every m.card. The “main” key is, for example, a symmetrical key according to TDES with a key length of at least 168 bits. As an alternative, keys according to other encryption methods and with other key lengths, e.g. asymmetrical keys with a length of 1024 bits, can also be used, whereby in the case of asymmetrical methods, for example, the private keys are kept in the certification authority and the public key is kept at the cryptographic modules m.cards. In order to enhance the security, when asymmetrical keys are used, the “public” key component in the cryptographic module m.card is not actually made public but rather, in a likewise secure manner, it is introduced into the cryptographic module and would not be ascertainable by the recipient. For security reasons, the “main” key is at least duplicated so that, if need be, the possibility exists in the certification authority as well as in the m.cards to turn to a second or even to additional “main” keys main₂, mainₙ. In order to simplify the description below, regardless of whether symmetrical or asymmetrical keys are used as the “main” key, the symmetrical variant is presented and explained. With the asymmetrical variant, the key main, at the certification authority would correspond to the private key and the key main₁ in the cryptographic module would correspond to the matching public key.

In order to encrypt their audio and video media, the individual publishers receive a new “media” key med_{I} from the certification authority, for example, every year (see Step 1 in FIG. 2). This generally symmetrical key indirectly encrypts the data contents, namely, via changing “melody” keys, subsequently referred to as the “key melody”, (see further below for explanation). Other encryption methods (e.g. asymmetrical or on the basis of elliptical curves) are also possible. Since the key med_{I} is not available for decryption in the m.card, said key is supplied together with the data contents of the audio and video media, in once again encrypted form. The publisher “media” key is encrypted at the certification authority with the “main” key main₁. The publisher “media” key (med_{I})ₘₐᵢₙ, which is encrypted with the “main” key, is also digitally signed by the certification authority sig_{CA}{(med_{I})ₘₐᵢₙ}. In this process, the certification authority creates a so-called digital fingerprint of the encrypted publisher “media” key and this digital fingerprint is then encrypted with the private signing key of the certification authority priv_{CA} (see Steps 2 and 3 in FIG. 2).

In order to prevent the publisher from calculating the “main” key by means of crypto-analysis or by trying out all possible key combinations, through the presence of the pair consisting of the “media” key and the “media” key that was encrypted with the top-secret “main” key, the publisher only has access to the “media” key in a cryptographic module in such a way that the latter cannot read out the “media” key but can only use it in accordance with the application purpose.

This signature of the certification authority is checked later in the cryptographic module m.card by the self-certificate of the certification authority that is saved there and that contains the public counterpart pub_{CA} of the signing key of the certification authority as well as, in turn, its signature with the signing key. As an alternative, especially if there is a lack of storage capacity in the cryptographic module, it is also possible for only the public key of the certification authority to be saved there. Likewise, in case of a lack of storage capacity, a summary of the two key components, main₁ and pub_{CA}/priv_{CA}, which are present in the certification authority and in the cryptographic module, is possible, although this lowers the security level.

Data contents are now encrypted by the publisher with so-called “melody” keys that change in a time sequence (for instance, every minute or second), and that subsequently form the so-called “key melody”. Advantageously, these changing “melody” keys are random keys according to any desired, for example, symmetrical, method such as TDES with 128 bits. As an alternative, other keys can also be used as random keys (see Step 4 in FIG. 2).

In order to permit the later decryption of the data contents encrypted with the key melody, the key melody is encrypted with the “media” key of the publisher med_{I} and, together with the encrypted audio and video information, transmitted to the recipient via the transmission channel or medium (see Step 5 in FIG. 2). The key melody encrypted with the “media” key is called the “crypto-melody”.

The “media” key (medi)main originally provided to the publisher by the certification authority (see Step 6 in FIG. 2) as well as the certificate or digital signature of the encrypted “media” key sig_{CA}{(med_{I})ₘₐᵢₙ), likewise provided by the certification authority, are also transmitted to the recipient (see Step 7 in FIG. 2).

Thus, to summarize, at least the following four pieces of information are transferred to the recipient via the transmission channel or via the medium, together with the actual audio and video information (additional information can contain authorizations and utilization information such as, for instance, prices):
Media data encrypted with the key melody: (media data)_{key melody}
The key melody encrypted with the “media” key: (key melody)_{medI}
The “media” key encrypted with the “main” key: (med_{I})ₘₐᵢₙ
The certificate of the “media” key or the digital signature of the “media” key created by the certification authority: sig_{CA}{(med_{I})ₘₐᵢₙ}

Prior to the decryption of the data contents, the “media” key med_{I} is ascertained in the m.card. Since this key is still in encrypted and signed form together with the audio and video media, first of all, the certificate or the signature of the certification authority is checked with the public key of the certification authority pub_{CA} that is present in the m.card (see Step 8 in FIG. 2). Subsequently, the “media” key is decrypted with the “main” key main₁ that is present in the m.card and then used for the decryption operation (see Step 9 in FIG. 2).

Regardless of whether the audio and video media are to be played immediately or else stored temporarily, the cryptomelody is now decrypted into the key melody, making use of the previously decrypted “media” key (see Step 10 in FIG. 2).

This is where the advantage of using changing melody keys that make up the key melody now becomes evident. During the course of processing the data stream of the audio and video data, taking into account the computing capacity of the cryptographic module, only one media key at a time has to be processed in this module, and said key is valid for a specific period of time. Even if one single melody key were to be become publicly known, for example, by crypto-analysis or trial and error, this would only have consequences for a short sequence of audio and video data that would then no longer be protected.

Like the “media” key, the key melody must not be read out. This is ensured through the use of the cryptographic module.

If the audio and video media are to be played immediately, then first of all, the certificate sig_{CA}{pubᵣₑ} issued by the certification authority for the playback unit (or for that model of the playback unit) is transferred from the playback unit to the cryptographic module where it is checked using the saved public key of the certification authority pub_{CA} (see Step 11 in FIG. 2). For practical reasons, as a rule, the asymmetrical keys of the playback unit pubᵣₑ and privᵣₑ are not individually different pairs of keys but rather keys that are changed with each new model of the playback unit and that are identical within each model.

After positive verification, a random or unpredictable temporary playback key rdm is generated in the cryptographic module, then encrypted with the public key of the playback unit (rdm)_{pubre} taken from the previously verified certificate and transferred to the playback unit (see Step 12 in FIG. 2).

Subsequently, in the cryptographic module, the key melody is encrypted with the playback key rdm (see Step 13 in FIG. 2) and, together with the media data that is still encrypted, transferred to the playback unit (see Step 14 in FIG. 2). The playback key thus takes over the function of a temporary “media” key. “Intercepting” the data exchanged between the cryptographic module and the playback unit cannot be used for unauthorized pirated copies since the encrypted key melody cannot be decrypted.

The playback key, with which the key melody can be decrypted and with which finally the media data can be decrypted for final playback, is decrypted in the playback unit.

If the audio and video media are not going to be played immediately but rather first temporarily stored as a local copy, then, after an appropriate verification of the utilization rights, the unencrypted key melody that is present in the cryptographic module is encrypted with a “card” key med_{card} that is individually associated with the cryptographic module and securely saved there (see Step 15 in FIG. 2). The key melody that is thus once again encrypted to form a card-specific crypto-melody is stored, together with the media data that is still encrypted, on any desired data medium, e.g. on the hard drive of a PC (see Step 16 in FIG. 2).

This card key functions like a publisher “media” key but as a rule, in contrast to the latter, it does not accompany the audio and video media for security reasons.

In an optional alternative, special card keys as well as the publisher “media” key, can accompany the audio and video media in encrypted form. The card key, like with the publisher “media” key, is encrypted with another “main” key that is present in every key. By the same token, it is advantageous with this alternative to add the encrypted card key to the audio and video media, together with a signature of a certification authority. Through this alternative, the audio and video media encrypted with a card can be played via another card. In this manner, audio and video media can become “re-publishable”, optionally for a fee.

The use of main, media and signing keys reduces the overall risk of corruption of the entire system: by using relatively few “media” keys (e.g. one per publisher per year), the sensitive “main” key is used as little as possible, as a result of which the discovery of the key within the scope of crypto-analysis is made more difficult. However, even in the actually serious event that the “main” key (which is, of course, present in every m.card) is discovered, this does not lead to a failure of the entire system since for this to happen, it would likewise be necessary to discover the well-secured signing key of the certification authority. Only through the interaction of the “main” key, the “media” key and the signing key is a simple and secure copy and utilization protection ensured.

1. A system and method for creating and distributing copy-protected and utilization-protected electronic audio and video media and their data contents, whereby the data contents of the electronic media are encrypted in such a way that they cannot be completely played or displayed without the execution of cryptographic processes at the recipient who is authorized within a certain scope of utilization and in such a way that, if the electronic media are transferred to third parties, complete playback is not possible at all or else not without once again carrying out appropriate cryptographic processes, characterized in that a cryptographic module at the recipient is used that decrypts or deciphers completely or partially encrypted or enciphered data contents of electronic audio and video media or keys for decrypting or deciphering these data contents and subsequently forwards them, again in an encrypted or enciphered form, to a playback unit in such a way that the audio and video information can be played in the playback unit without the electronic data contents being present in unencrypted form along the transmission route, at the input or at the output of the cryptographic module or at the input of the playback unit.

2. The method according to claim 1, characterized in that the cryptographic module can distinguish among various encryptions, whereby the distinction allows conclusions to be drawn about the authorship, ownership and utilization rights, for example, to play the media or to make copies.

3. The method according to claim 1, characterized in that the author, producer, processor or distributor of the electronic audio and video media partially or completely encrypts or enciphers the unencrypted initial data in such a way that the electronic audio and video media or the keys for decrypting or deciphering the electronic audio and video media can be decrypted or deciphered again in the cryptographic module of the recipient.

4. The method according to claim 1, characterized in that the completely or partially performed encryption or enciphering of the electronic audio and video media or of the “melody” keys for decrypting or deciphering these media takes place at the author, producer, processor or distributor with a “media” key which, once again in encrypted or enciphered form, accompanies the electronic audio and video media, whereby the encryption or enciphering of the “media” key is carried out with a “main” key so that it can be reversed in the cryptographic module at the recipient by means of decrypting or deciphering.

5. The method according to claim 1, characterized in that, if need be, all of the encryption or enciphering procedures at the author, producer, processor or distributor, which can be reversed again by means of decryption or deciphering in the cryptographic module at the recipient, can be carried out with two or more alternative encryption or enciphering methods or keys for this purpose.

6. The method according to claim 1, characterized in that the “media” key for partially or completely encrypting or enciphering the electronic audio and video media or the “melody” key for decrypting or deciphering these media, which accompanies the electronic audio and video media, is provided with a digital signature that can be verified in the cryptographic module at the recipient.

7. The method according to claim 1, characterized in that, after decrypting or deciphering the electronic audio and video information stemming from the author, producer, processor or distributor or the “melody” keys for decrypting or deciphering this information, the cryptographic module at the recipient once again encrypts or enciphers this information in such a way that only a playback unit can decrypt or decipher it.

8. The method according to claim 7, characterized in that the “media” key that is used in the cryptographic module to encrypt or encipher the electronic audio and video information or the “melody” key that is used to decrypt or decipher this information for transmission to the playback unit, is exchanged securely and authentically between the cryptographic module and the playback device.

9. The method according to claim 7, characterized in that the “playback” key that is used for transmission to the playback unit for encrypting or enciphering the electronic audio and video information or the “melody” key for decrypting or deciphering this information in the cryptographic module, is generated according to the random principle or according to algorithms that make them more difficult to predict.

10. The method according to claim 7, characterized in that the “playback” keys that are used for transmission to the playback unit for encrypting or enciphering the electronic audio and video information or the “melody” key for decrypting or deciphering this information in the cryptographic module differ from one playback unit to the next.

11. The method according to claim 1, characterized in that, after decrypting or deciphering the audio and video information stemming from the author, producer, processor or distributor or the “melody” key for decrypting or deciphering this information, the cryptographic module at the recipient once again encrypts or enciphers this information in such a way that the cryptographic module is once again capable of decrypting or deciphering this audio and video information or the “melody” keys for decrypting or deciphering this information.

12. The method according to claim 11, characterized in that those “card” keys that are used at the cryptographic module when the cryptographic module itself is supposed to perform the later decryption or deciphering differ from one cryptographic module to the next.

13. The method according to claim 11, characterized in that, after decrypting or deciphering the audio and video information that was previously encrypted by the “card” key itself or the “melody” key for decrypting or deciphering this information, the cryptographic module at the recipient once again encrypts or enciphers this information or the corresponding “melody” keys in such a way that only a playback unit can decrypt or decipher them.
